(19) United States
(12) Patent Application Publication
(10) Pub. No.: US 2009/0098455 A1
(43) Pub. Date: Apr. 16, 2009

(54) BATTERY STRUCTURE

(75) Inventor: Min-Che Kao, Taipei (TW)

Correspondence Address: QUINTERO LAW OFFICE, PC, 2210 MAIN STREET, SUITE 200, SANTA MONICA, CA, 90405, US

(73) Assignee: ASUSTEK COMPUTER INC., Taipei City (TW)

(21) Appl. No.: 12/173,781

(22) Filed: Jul. 15, 2008

(30) Foreign Application Priority Data
Oct. 15, 2007 (TW) TW96138463

(51) Int. Cl. H01M 2/02

(52) U.S. Cl. 429/187

(57) ABSTRACT

A battery structure includes a main body and a pulling member. The main body has a first outer surface and a second outer surface which are parallel to each other. The pulling member is connected to the first outer surface and the second outer surface and forms a holding portion extending from the main body. When taking the battery structure out of an electronic device, a user only needs to pull the holding portion, and then the main body can be separated from the electronic device. Whatever the pulling direction is, the pulling member cannot be destroyed, so the convenience in usage and durability can be increased.

### CROSS REFERENCE TO RELATED APPLICATIONS

This application claims the benefit of Taiwan Application No. 96138463 filed Oct. 15, 2007.

### BACKGROUND OF THE INVENTION

1. Field of the Invention

The invention relates to a battery structure and, more particularly, to a battery structure which can be easily taken out of an electronic device.

2. Description of the Related Art

Please refer to FIG. 1A and FIG. 1B, a conventional battery 10 includes a main body 11, a pulling belt R and a package film P. One end of the pulling belt R is pasted to a first lateral surface 101 of the main body 11. The other end of the pulling belt R extends from the main body 11 toward outside. The pulling belt R is covered with the package film P to beautify the external appearance of the battery 10. The battery 10 can be assembled in an electronic device by making the first lateral surface 101 or a second lateral surface 102 face the electronic device.

When replacing the battery 10, a user can apply an external force to the pulling belt R along a direction which is opposite to the direction of assembling the battery, and then the whole battery can be indirectly taken out. At this time, if the battery 10 is assembled in the electronic device with the first lateral surface 101 facing the electronic device, pulling the pulling belt R (the direction of pulling the pulling belt R as shown in FIG. 1A) will make the battery 10 successfully be taken out. But if the battery 10 is assembled in the electronic device with the second lateral surface 102 facing the electronic device, pulling the pulling belt R (the direction of pulling the pulling belt R as shown in FIG. 1B) will not only make the battery 10 not be taken out, but also make the package film P separate from the main body 11 probably. After the battery 10 is assembled and taken out for many times, the pulling belt R is possible to fall off, and this will increase the inconvenience in usage.

### BRIEF SUMMARY OF THE INVENTION

The invention provides a battery structure which includes a main body and a pulling member. The main body has a first outer surface and a second outer surface which are parallel to each other. The pulling member is connected to the first outer surface and the second outer surface and forms a holding portion which extends from the main body.

The battery structure of the invention includes a pulling member connected to the two parallel outer surfaces of the main body, respectively. The pulling member is firmly attached to the main body. As a result, whatever the surface of the main body is set to face an electronic device, the convenience of pulling out the battery structure cannot be affected. In addition, since the pulling member is not easy to be separated from the main body, a package member is not destroyed when the pulling member is pulled.

### BRIEF DESCRIPTION OF THE SEVERAL VIEWS OF THE DRAWINGS

FIG. 1A and FIG. 1B are schematic diagrams showing front and back surfaces of a conventional battery structure.

FIG. 2A is an exploded diagram showing the main body and the pulling member of a battery structure in a preferred embodiment of the invention.

FIG. 2B is a schematic diagram showing the main body and the pulling member of a battery structure in a preferred embodiment of the invention.

FIG. 3 is a schematic diagram showing a battery structure in a preferred embodiment of the invention.

### DETAILED DESCRIPTION OF THE EMBODIMENTS

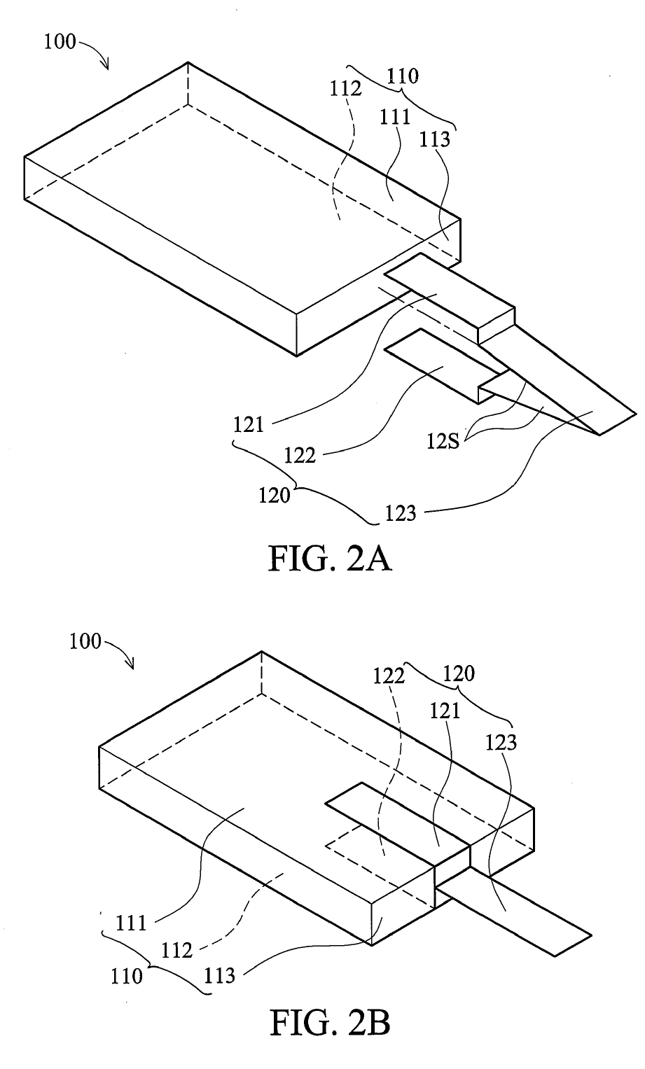

A battery structure 100 of the invention can be applied to common electronic products to provide electricity. Please refer to FIG. 2A and FIG. 2B, and the battery structure 100 includes a main body 110, and a pulling member 120. When the battery structure 100 is assembled in an electronic device, the main body 110 can be separated from the electronic device by the pulling member 120.

The main body 110 includes a first outer surface 111, a second outer surface 112 and a third outer surface 113. The first outer surface 111 and the second outer surface 112 are parallel with each other, and the third outer surface 113 is perpendicular to the first outer surface 111 and the second outer surface 112. The pulling member 120 is a bar-shape member and has a first end 121 and a second end 122.

The first end 121 of the pulling member 120 is connected to the first outer surface 111 of the main body 110, and the second end 122 of the pulling member 120 is connected to the second outer surface 112 of the main body 110. In the embodiment, the first end 121 and the second end 122 are connected to the main body 110 in an attaching mode. And then the first end 121 and the second end 122 of the pulling member 120 are bent inward along the third outer surface 113 of the main body 110. Inner surfaces 12S of the first end 121 and the second end 122 contact and are attached with each other to form a holding portion 123 extending from the third outer surface 113 of the main body 110.

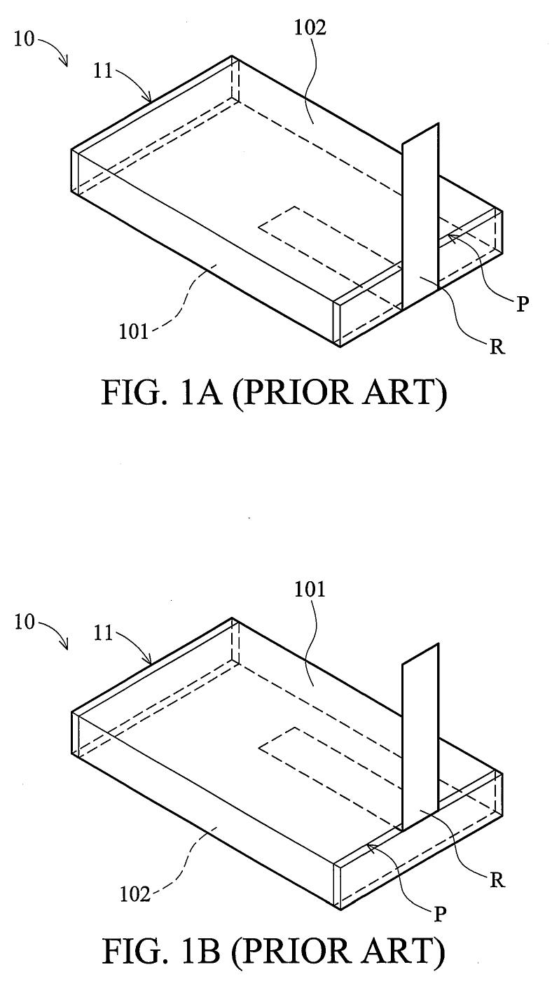

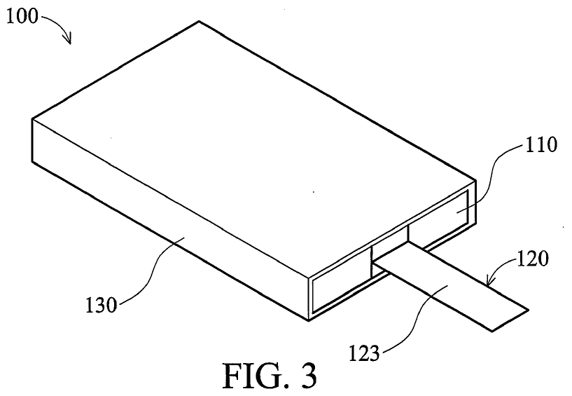

Finally, the main body 110 can be covered with a package member 130, such as the outer housing shown in FIG. 3. It also can be covered with the package film P shown in FIG. 1B. Then, the first end 121 and the second end 122 of the pulling member 120 are fixed between the package member 130 and the main body 110. In the embodiment, the package member 130 comprises an outer housing and a package film, such as a polyester film or the combination of the above-mentioned.

When taking the battery structure 100 out of the electronic device, a user only needs to pull the holding portion 123 to make the main body 100 separated from the electronic device. Therefore, the user does not need to care whether the first outer surface 111 or the second outer surface 112 is set to face the electronic device when the battery structure 100 is assembled.

The battery structure 100 of the invention has the pulling member 120 which is firmly attached to the two parallel outer surfaces of the main body 110, respectively. As a result, whatever the surface of the main body 110 is set to face the electronic device, the convenience of pulling out the battery structure 100 cannot be affected. In addition, since the pulling member 120 is not easy to be separated from the main body 110, the package member 130 cannot be destroyed when the pulling member 120 is pulled.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A battery structure comprising:
a main body having a first outer surface and a second outer surface which are parallel with each other; and
a pulling member connecting to the first outer surface and the second outer surface and forming a holding portion, wherein the holding portion extends from the main body.

2. The battery structure according to claim 1, wherein the pulling member has a first end and a second end which are connected to the first outer surface and the second outer surface, respectively.

3. The battery structure according to claim 1, wherein the main body has a third outer surface which is perpendicular to the first outer surface and the second outer surface, and the holding portion extends from the third outer surface.

4. The battery structure according to claim 1 further comprising a package member which covers the battery structure.

5. The battery structure according to claim 4, wherein the package member is a polyester film.

6. The battery structure according to claim 4, wherein the package member is an outer housing.
